(19) United States
(12) Patent Application Publication
(10) Pub. No.: US 2009/0283212 A1
(43) Pub. Date: Nov. 19, 2009

(54) Method for Sealing a Pipe Section

(76) Inventor: Johann Kubel, Kasten (AT)

Correspondence Address: LERNER GREENBERG STEMER LLP, P O BOX 2480, HOLLYWOOD, FL, 33022-2480, US

(21) Appl. No.: 12/468,542

(22) Filed: May 19, 2009

(30) Foreign Application Priority Data
May 19, 2008 (AT) A-797/2008

(51) Int. Cl. B29C 65/54

(52) U.S. Cl. 156/293

(57) ABSTRACT

A pipe section in a pipe is quickly sealed with a hardenable, partially hardened, flat insert mat or prepreg. Adhesive is applied at least to the outer surface of the insert, adhesive is introduced between two superposed end regions of the insert, and to insert is given the form of a cylinder jacket. The insert is placed on an elongated balloon, a part of the insert is placed against the balloon and its jacket continuously covered at least in a partial area, and the remaining region of the insert which does not adjoin the balloon is turned into a loop and pressed against the outer surface of the insert. The balloon with the insert is inserted into the pipe and positioned at the leak or weak location. Then the balloon is inflated, such that the insert is pressed against the inside wall of the pipe and the adhesive is hardened.

### CROSS-REFERENCE TO RELATED APPLICATION

This application claims the priority, under 35 U.S.C. § 119, of Austrian patent application A 797/2008, filed May 19, 2008; the prior application is herewith incorporated by reference in its entirety.

### BACKGROUND OF THE INVENTION

### Field of the Invention

The invention relates to a method for quickly sealing a pipe section in a pipe by means of a hardenable, partially hardened, flat, in particular rectangular, insert or prepreg.

Methods of this type are used, in particular, for sealing pipes on the inside, preferably in waste water conduits.

A fundamental problem of the prior art is that sealing pipes is very time consuming and requires a great deal of work. Fleeces which are saturated in synthetic resin and then applied to a balloon and inserted into the pipe are often used in methods according to the prior art. In part, these steps are very unclean since the adhesive applied to the fleece sometimes continues to adhere to the balloon or drips from the fleece. It is not easily possible to install the fleece accurately.

### SUMMARY OF THE INVENTION

It is accordingly an object of the invention to provide a method for sealing a pipe which overcomes the above-mentioned disadvantages of the heretofore-known devices and methods of this general type and which allows a pipe to be sealed quickly and efficiently.

With the foregoing and other objects in view there is provided, in accordance with the invention, a method of quickly sealing a pipe section in a pipe, the method which comprises the following method steps:

a) providing a substantially flat insert having an outer surface intended to adjoin a pipe for sealing the pipe, and having two mutually opposite end regions;

b) applying an adhesive to the outer surface of the insert;

c) overlapping the two opposite end regions of the insert to form an overlapping region, introducing adhesive into the overlapping region between the end regions, for forming the insert into a cylinder jacket or annular cylinder having a diameter substantially corresponding to an inside diameter of the pipe or slightly smaller than the inside diameter;

d) placing the insert onto an elongated, substantially cylindrical balloon, and maintaining a diameter of the balloon smaller than the inside diameter of the pipe;

e) placing a part of the insert against the balloon to cover a jacket surface continuously at least in a partial region thereof, and turning a remaining region of the insert, which does not adjoin the balloon, into a loop, and optionally pressing the loop against the outer surface of the insert;

f) inserting the balloon with the insert into the pipe and positioning the insert carried by the balloon at an area of the pipe section to be sealed; and

g) inflating the balloon, and pressing the insert against the inside wall of the pipe and hardening the adhesive.

In a preferred embodiment of the invention, the insert is a hardenable, partially hardened, insert sheet or prepreg. Further, the adhesive or glue may be applied over the entire outer surface of the insert. The placing step comprises slipping the insert over the balloon or wrapping and folding the insert about the balloon.

It was found to be advantageous that the adherence of the insert to the balloon or the loss of the adhesive prior to or during installation of the insert into the pipe is avoided by applying the adhesive from the outside. In addition, there is the advantage that the adhesive is distributed especially uniformly on the surface of the insert or pipe and a good adhesive effect of the insert to the pipe is obtained. Furthermore, wear of the insert on the pipe is prevented by the compact mounting of the insert during the installation.

An especially simple forming of an insert is made possible where the insert mat or prepreg is rectangular in its original form.

In accordance with an added feature of the invention, the overlapping region extends about 5% to 15% of the inner circumference of the pipe in peripheral direction of the formed cylindrical insert. The adhesion of the pipe insert to the balloon is thus improved during installation of the insert into the pipe.

In accordance with an additional feature of the invention, a layer of further adhesive is applied to the outer end regions of the insert in the area of the openings on the outer peripheral surfaces of the cylindrically shaped insert. This feature further improves the adhesion of the insert on the inner surface of the pipe. Furthermore, the density properties of the insert vis-à-vis the pipe are improved.

In accordance with another feature of the invention, the further adhesive is a water-hardening or waterproof epoxide resin. The time of the hardening can be preset especially accurately in this case.

In accordance with a further feature of the invention, the adhesive may include or consist of thermo-setting or UV-hardenable resin. This results in an especially advantageous adhesive effect of the insert on the pipe.

In accordance with again an added feature of the invention, the balloon is a UV-permeable balloon and the adhesive is irradiated and cured with UV light from inside the balloon. A simple hardening from the inside is made possible with these features.

In accordance with again a further feature of the invention, there is provided a partially hardened, flexible and/or deformable insert. Preferably, the insert is an extensible insert having a rubber-like consistency. This renders possible an especially simple mounting of the insert on the balloon and a good adaptation of the insert to the inside area of the pipe, including the resultant particularly effective sealing of the pipe section.

In accordance with yet an added feature of the invention, a protective foil may be wrapped around the insert attached to the balloon and provided with the adhesive, prior to insertion into the pipe. The foil is subsequently removed after the positioning of the insert and prior to inflating the balloon. Damage to the insert and/or loss of adhesive from the insert during installation of the insert into the pipe is prevented.

A uniform adhesive distribution on the surface is obtained especially easily when the above method steps are carried out in a sequence b), d), c), e), f), and g).

The step sequence d), b), c), e), f), and g), furthermore, enables especially drip-free installation of the insert into the pipe.

Other features which are considered as characteristic for the invention are set forth in the appended claims.

Although the invention is illustrated and described herein as embodied in a method for sealing a pipe section, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a longitudinal section through a pipe segment in which a balloon, which is carried by a mobile robot, installs an insert into the pipe;

FIG. 2 is an insert in an unwound or developed view;

FIG. 3 is an end view showing an insert placed on a balloon and having those portions that do not adjoin with their entire surface are folded together to form a loop; and

FIG. 4 is a side view of the overlapping region which results when the insert is rolled together to form a hollow cylinder.

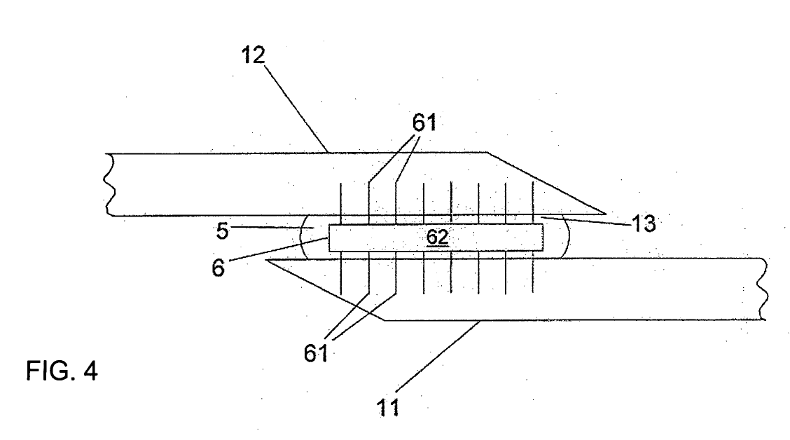

### DETAILED DESCRIPTION OF THE INVENTION

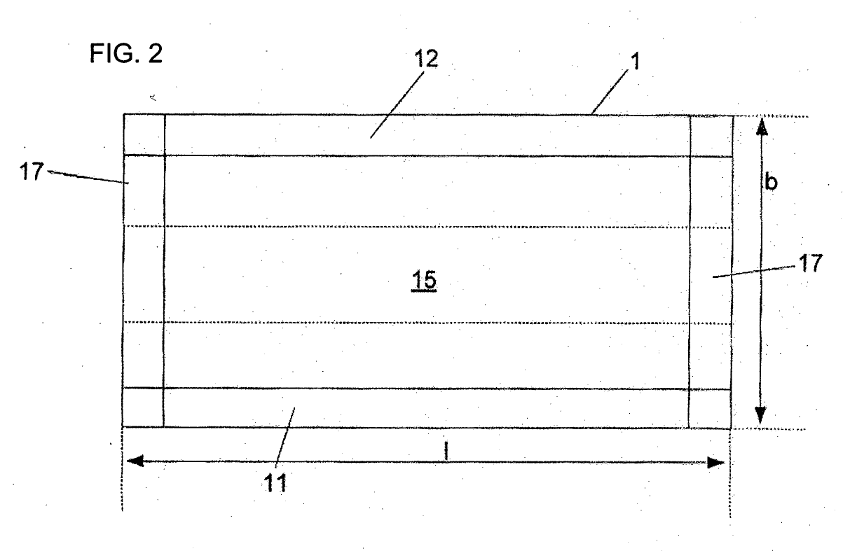

Referring now to the figures of the drawing in detail and first, particularly, to FIG. 2 thereof, there is shown a rectangular insert 1. A length/of the insert 1 thereby corresponds to about 120% to 200% of a length of the damaged point to be sealed. A width b of the insert 1 is in the range of between 105% and 130% of the inner circumference of a pipe 2 to be sealed. The two opposite end regions 11, 12 are made to coincide prior to the installation of insert 1 into the pipe 2. Adhesive 5 is inserted into the overlapping region 13 between the two end regions 12, 13 formed by the covering, as a result of which the insert 1 is given the form of a cylinder jacket, a hollow cylinder or an annular cylinder. The diameter of the insert 1 thereby corresponds to the inside diameter of the pipe 2 with slight deviations or is slightly smaller than it.

The width of the end regions 11, 12 corresponds to the width of the overlapping region and corresponds to about 5% to 15% of the inner circumference of the pipe or 5% to 30% of the width b of the insert.

Furthermore, in FIG. 2, two outer end regions 17 on the insert are shown which are situated in the area of the openings on the outer peripheral surfaces of the cylindrically formed insert 1. The width of these outer end regions is 2% to 10% of the length of the insert 1. A further adhesive layer 51 is applied to these outer end regions 17.

Preferably, this additional adhesive layer 51 can be formed with a hypoxide resin which is waterproof or which can be hardened (cured) in water.

The insert 1 is formed from a homogeneous material. Typically, the two surfaces of the insert 1 have the same surface quality. An adhesive 5 is applied to one of the two sides on the surface, in particular over the entire surface. That side to which the adhesive 5 has been applied will subsequently form the outer surface when the insert 1 is rolled up.

In one embodiment, the insert may be a prepreg, i.e., a pre-impregnated composite fiber product, typically in the form of a weave or unidirectional fibers pre-impregnated with partially cured resin.

The two aforementioned procedural steps, namely applying the adhesive 5 and rolling the rectangular insert 1 up to form a cylinder can basically be carried out in either desired sequence.

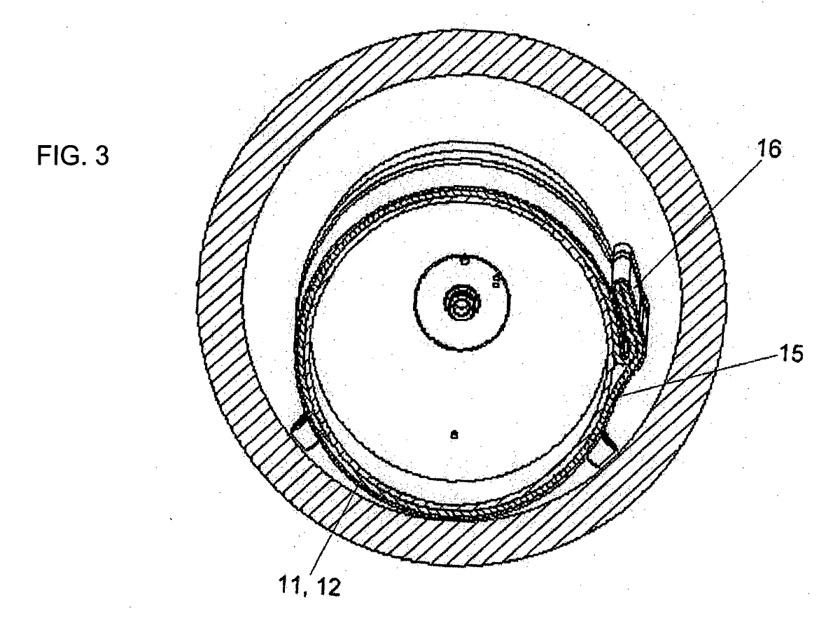

FIG. 3 shows the insert 1 applied to an elongated, substantially cylindrical balloon 4, slipped over it or placed about it. The diameter of the balloon 4 is thereby less than the inside diameter of the pipe 2. To enable a simple installation of the insert 1 into the pipe 2, the diameter of the balloon 4 is selected at a value of less than 60% to 80% of the inside diameter of the pipe 2. The insert 1 with its inner surface is joined over the entire surface to the outer surface of the balloon 4. A part of the insert 1 is placed on the balloon 4 and its surface 41 thereby continuously covers at least a partial area of the balloon 4. Due to the different radii and diameters of the balloon 4 and the cylindrical insert 1, a residual area 15 which does not adjoin the balloon 4 remains on the insert 1. This non-adjacent area 15 of the insert 1 is turned up in the form of a loop 16 and the loop 16 is pressed against the balloon 4.

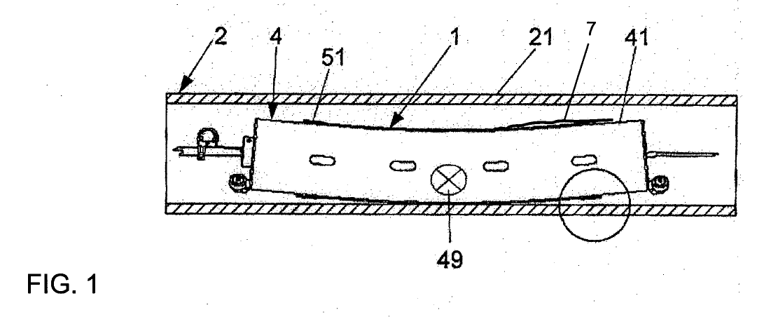

FIG. 1 shows how the balloon with the insert 1 is inserted into the pipe 2 and positioned in it such that the insert 1 carried by the balloon 4 comes to lie in the region of the pipe section 21 to be sealed. The balloon 4 is then inflated and the insert 1 pressed against the inside wall of the pipe 2. Subsequently, a UV lamp 49 situated inside the balloon 4 is switched on, as a result of which the adhesive 5 hardens.

The inserted insert 1 is flexible and/or deformable, in particular extensible, and has a rubbery consistency; after hardening, or curing, it is rigidly secured with the inside wall of the pipe.

A preferred embodiment of the method according to the invention is in that the insert 1 provided with adhesive 5 and applied to the balloon 4 is surrounded with a protective foil 7 prior to installation in the pipe 2. A portion of the foil 7 is diagrammatically illustrated in FIG. 1. After the final positioning of the insert 1 in the pipe 2 and prior to inflating the balloon 4, this protective foil 7 is removed. The fundamental advantage of the protective foil 7 can be seen in the following context: During installation of a long insert 1 into the pipe 2, the balloon 4 and the insert attached to this balloon 4 sag. When the insert 1 moves in longitudinal direction of the pipe 2, said insert 1 drags on the bottom of the pipe 2, as a result of which adhesive 5 on the pipe 2 drips off and material is eventually rubbed off the insert 1. However, if the insert 1 is wrapped with a protective foil 7, this is effectively prevented which, on the one hand, prevents the material wear from the insert 1 on the bottom of the pipe 2 and, on the other hand, the adhesive 5 from dripping off the insert 1.

As already mentioned, the chronological sequence of the individual procedural steps is unimportant and what is essential is that the application of the adhesive, making the opposite end regions 11, 12 coincide, affixing the insert 1 to the balloon 4 and forming the loop 16 prior to inserting the balloon 4 with the insert 1 into the pipe 2 are carried out. The balloon 4 is inflated last. In this connection, it was found to be especially advantageous to first apply the adhesive 5 to the surface of the insert 1, then affix the insert 1 to the balloon 4, then make the two opposite end regions 11, 12 coincide and subsequently place the insert 1 on the balloon 4 and form a loop 16 from the non-adjoining areas.

Furthermore, it is possible to interchange the first two procedural steps, in this case, the insert 1 is first affixed to the balloon 4 and then the adhesive is applied to the outer surface of the insert 1.

To prevent relative slippage between the two end regions 11, 12 during inflation of the balloon, it can be provided that adhesive 5 be inserted in the overlapping region 13 between the two end regions 11, 12. Furthermore, to ensure additional mechanical stability, a cog-like mounting element or a cog 6 can be used which has extensions or pins 61 toward two opposite directions. The extensions or pins penetrate into the insert 1 during pressure impacts. The pins 61 thereby have a length of up to 100% of the thickness of the insert 1. Furthermore, the cog comprises a body or a housing 62 from which the pins 61 project in opposite directions. The length of the body 62 of the cog 6 thereby corresponds to the length/of the insert 1. The width of the body 62 is less than the width of the overlapping region 13 and is preferably in the range of between 40% and 80% of the width of the region. The thickness of the body 62 is to be kept as small as possible and is about in the range of 5% to up to 20% of the thickness of the insert 1. This is necessary as, otherwise, the thickness of the insert is very large in the area of the overlapping region 13 and the radius of the pipe 2 would narrow non-symmetrically.

In particular, the adhesive 5 is formed with UV-hardenable (i.e., UV-curable) resin or consists of UV-hardenable resin. In this case, a UV-permeable balloon 4 is used. After positioning the insert 1, the adhesive 5 is irradiated by means of UV light from inside the balloon 4 and hardened.

The object of proceeding in this manner is to reduce the time required for the hardening and to specifically control the time of the hardening of the resin. A further object is to allow the resin to harden in the shortest time possible, whereby the resin should, if possible, not harden prior to being applied to the pipe insert.

The invention enables an especially accurate control over the hardening process, whereby the hardening can be monitored with little human interaction by means of a radio remote control with simultaneous viewing and by means of a camera with radio transmission. The time of the hardening of the resin can thereby be very precisely set. The insert can be exactly positioned and the hardening process subsequently controlled by a camera located in the area of the balloon.

1. A method of quickly sealing a pipe section in a pipe, the method which comprises the following method steps:
a) providing a substantially flat insert having an outer surface intended to adjoin a pipe for sealing the pipe, and having two mutually opposite end regions;
b) applying an adhesive to the outer surface of the insert;
c) overlapping the two opposite end regions of the insert to form an overlapping region, introducing adhesive into the overlapping region between the end regions, for forming the insert into a cylinder jacket or annular cylinder having a diameter substantially corresponding to an inside diameter of the pipe or slightly smaller than the inside diameter;
d) placing the insert onto an elongated, substantially cylindrical balloon, and maintaining a diameter of the balloon smaller than the inside diameter of the pipe;
e) placing a part of the insert against the balloon to cover a jacket surface continuously at least in a partial region thereof, and turning a remaining region of the insert, which does not adjoin the balloon, into a loop, and optionally pressing the loop against the outer surface of the insert;
f) inserting the balloon with the insert into the pipe and positioning the insert carried by the balloon at an area of the pipe section to be sealed; and
g) inflating the balloon, and pressing the insert against the inside wall of the pipe and hardening the adhesive.

2. The method according to claim 1, wherein the insert is a hardenable, partially hardened, insert sheet or prepreg.

3. The method according to claim 1, wherein the applying step comprises applying the adhesive over the entire outer surface of the insert.

4. The method according to claim 1, wherein the placing step comprises slipping the insert over the balloon or folding the insert about the balloon.

5. The method according to claim 1, wherein the insert is rectangular in an original form thereof.

6. The method according to claim 1, wherein the overlapping region extends about 5% to 15% of the inner circumference of the pipe in peripheral direction of the formed cylindrical insert.

7. The method according to claim 1, which comprises applying a layer of further adhesive to the outer end regions of the insert in the area of the openings on the outer peripheral surfaces of the cylindrically shaped insert.

8. The method according to claim 7, wherein the further adhesive is a water-hardening or waterproof epoxide resin.

9. The method according to claim 1, wherein the adhesive comprises thermo-setting or UV-hardenable resin.

10. The method according to claim 1, wherein the adhesive consists of thermo-setting or UV-hardenable resin.

11. The method according to claim 1, which comprises providing a UV-permeable balloon, and irradiating and curing the adhesive with UV light from inside the balloon.

12. The method according to claim 1, wherein the providing step comprises providing a partially hardened, flexible and/or deformable insert.

13. The method according to claim 1, wherein the providing step comprises providing an extensible insert having a rubber-like consistency.

14. The method according to claim 1, which comprises wrapping a protective foil about the insert attached to the balloon and provided with the adhesive, prior to insertion into the pipe, and subsequently removing the protective foil after the positioning of the insert and prior to inflating the balloon.

15. The method according to claim 1, which comprises carrying out method steps b)-g) in a sequence b), d), c), e), f), and g).

16. The method according to claim 1, which comprises carrying out method steps b)-g) in a sequence d), b), c), e), f), and g).
